(19) United States
(12) Patent Application Publication
(10) Pub. No.: US 2011/0216041 A1
(43) Pub. Date: Sep. 8, 2011

(54) TOUCH PANEL AND TOUCH POSITION DETECTION METHOD OF TOUCH PANEL

(76) Inventors: Hyun-Min Cho, Seoul (KR); Sung-Jin Kim, Seongnam-si (KR); Jae-Byung Park, Seoul (KR); Jin-Hwan Kim, Suwon-si (KR); Don-Chan Cho, Seongnam-si (KR); Guk-Hyun Kim, Yongin-si (KR); Jong-Hee Kim, Hwaseong-si (KR); Yu-Kwan Kim, Metropolitan City (KR); Seul Lee, Seoul (KR)

(21) Appl. No.: 12/912,667

(22) Filed: Oct. 26, 2010

(30) Foreign Application Priority Data
Mar. 2, 2010 (KR) 10-2010-0018475

(51) Int. Cl. G06F 3/042

(52) U.S. Cl. 345/175

(57) ABSTRACT

A touch panel and a touch position detection method are presented. The touch panel includes: a touch unit, a light source unit array positioned along a first edge of the touch unit and including a first light source and a second light source; and a detection unit array positioned along a second edge and including a detection unit generating a detection signal by detecting light from the light source unit array. The first light source radiates light having a first optical axis, the first optical axis extending in a first direction that makes a first angle with respect to a reference direction, and the second light source radiates light having a second optical axis, the second optical axis extending in a second direction that makes the first angle with respect to the reference direction. The reference direction is perpendicular to the second edge.

### CROSS-REFERENCE TO RELATED APPLICATION

This application claims priority to and the benefit of Korean Patent Application No. 10-2010-0018475 filed in the Korean Intellectual Property Office on Mar. 2, 2010, the entire content of which is incorporated herein by reference.

### BACKGROUND OF THE INVENTION

(a) Field of the Invention

The present invention relates to a touch panel and a touch position detection method of a touch panel.

(b) Description of the Related Art

Display devices such as liquid crystal displays and organic light emitting displays, as well as various portable transmitting devices and other information processing devices use various input devices for receiving input from users. Typically, input devices have been some type of a keyboard or keypad placed near an output device, such as a screen. In recent years, touch panels that allow users to input commands or data by touching images on the screen have become increasingly popular as a combined output-and-input device.

A touch panel device allows a machine such as a computer, etc. to perform a desired command by placing a finger or a touch pen (e.g. stylus) onto a screen of the touch panel to write or draw characters or executing icons. A display device coupled to a touch panel determines whether or not a user's finger or the touch pen contacted the screen. The display device displays an appropriate image in response to the touch based on the information that was displayed at the position of the touch.

Touch panels may be largely divided into a resistive type, a capacitive type, an electro-magnetic type (EM), and an optical type in accordance with the touch detection method that is used.

Among them, the optical type uses light such as infrared rays, etc. and detects coordinates of a touch position by recognizing a change in the light with a sensing unit when a touch is made by disposing a light source and the sensing unit in the vicinity of the touch panel.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a touch panel that includes a touch unit that receives a touch; a light source unit array positioned along a first edge of the touch unit and including a first light source and a second light source; and a detection unit array positioned along a second edge facing the first edge of the touch unit and including a detection unit generating a detection signal by detecting light from the light source unit array. The first light source radiates light having a first optical axis to the touch unit, the first optical axis being in a first direction that makes a first angle with respect to a reference direction, and the second light source radiates light having a second optical axis to the touch unit, the second optical axis being in a second direction that makes the first angle with respect to the reference direction. The first direction and the second direction are opposite to each other with respect to the reference direction, which extends perpendicular to the second edge.

Fifty percent or more of a light amount of the light emitted from the first light source may be focused in a direction of the first optical axis, and 50% or more of a light amount of the light emitted from the second light source may be focused in a direction of the second optical-axis.

The first light source and the second light source may be alternately driven.

The detection unit may detect a change in the light from the first light source when the first light source is driven to generate a first detection signal and may detect a change in the light from the second light source when the second light source is driven to generate a second detection signal.

At least one of the first light source and the second light source may include a substantially linear light source extending along the light source unit array.

At least one of the first light source and the second light source are provided in plural and the plurality of light sources may be disposed in a line in the light source unit array.

The touch unit may include a material having a refractive index of 1 or higher.

The light emitted from the first light source may be radiated in directions having a range from a direction of the first optical axis to a direction that makes a second angle with respect to the direction of first optical axis, and the light emitted from the second light source may be radiated in directions having a range from a direction of the second optical axis to a direction that makes the second angle with respect to the direction of the second optical-axis.

A first edge of the touch unit may bend along surfaces of the first light source and the second light source.

The first angle may be equal to zero so that a direction of the first optical axis of the light emitted from the first light source and a direction of the second optical axis of the light emitted from the second light source may be the reference direction.

The light source unit array may further include a prism between the first and second light sources and the touch unit, and the prism may direct the light from the first light source in the first direction and the light from the second light source in the second direction in the touch unit.

In another aspect, the present invention provides a touch position detection method of the above-described touch panel including sensing a touch at a touch point; generating a first detection signal corresponding to the touch point by driving the first light source; generating a second detection signal corresponding to the touch point by driving the second light source; and calculating coordinates of the touch point positions of a peak of the first detection signal and a position of a peak of the second detection signal.

Fifty percent or more of a light amount of the light emitted from the first light source may be focused in a direction of the first optical axis, and 50% or more of a light amount of the light emitted from the second light source may be focused in a direction of the second optical axis.

In the calculating of the coordinates of the at least one touch point, a radiation direction of light from the first light source and the second light source passing through the at least one touch point may make the first angle with respect to the reference direction.

Two or more touch points may be positioned on a same optical axis of light emitted from at least one of the first light source and the second light source, and the method may further comprise detecting a position of the touch point by analyzing a height of the peak of the first detection signal and a height of the peak of the second detection signal.

The light emitted from the first light source may spread within a second angle with respect to the first optical axis in either direction of the first optical axis, and the light emitted from the second light source spreads within the second angle with respect to the second optical axis in either direction of the second optical axis.

Each of the first light source and the second light source may be provided in plural and the plurality of first light sources and the plurality of second light sources may be alternately disposed. The plurality of first light sources and the plurality of second light sources may be sequentially driven from one end of the light source array to the other.

The calculating of the coordinates of the at least one touch point may further entail using positions of the first light source and the second light source emitting light passing through the touch point.

### BRIEF DESCRIPTION OF THE DRAWINGS

FIG. 1 is a plan view of a touch panel according to an exemplary embodiment of the present invention;

FIG. 2(a) is a plan view showing the direction of light from a light source of a touch panel according to an exemplary embodiment of the present invention;

FIG. 2(b) is a plan view showing another exemplary embodiment of light sources of a touch panel according to an exemplary embodiment of the present invention;

FIGS. 3 and 4 are plan views showing a method of acquiring a detection signal when one portion of a touch panel is touched according to an exemplary embodiment of the present invention;

FIG. 5 is a plan view showing a method of calculating coordinates of a touch position from the method shown in FIGS. 3 and 4;

FIGS. 6 and 7 are plan views showing a method of acquiring a detection signal when one portion of a touch panel is touched according to another embodiment of the present invention;

FIG. 8 is a plan view showing a method of calculating coordinates of a position of a touch point from the method shown in FIGS. 6 and 7;

FIG. 9 is a plan view showing a method of calculating coordinates by acquiring a detection signal when two points of a touch panel are touched according to an exemplary embodiment of the present invention;

FIG. 10 is a plan view showing a method of acquiring a detection signal when two points or more of a touch panel are touched according to an exemplary embodiment of the present invention;

FIGS. 11(a) through 11(e) are diagrams showing various forms of a detection signal acquired by the method of FIG. 10;

FIG. 12 is a plan view showing a method of calculating coordinates of a position of a touch point from the method shown in FIG. 10;

FIG. 13 is a plan view showing a method of acquiring a detection signal when five points of a touch panel are touched according to an exemplary embodiment of the present invention;

FIG. 14 is a plan view showing a method of calculating coordinates of a position of each touch point from the method shown in FIG. 13; and

FIGS. 15 to 17 are plan views of a touch panel according to another embodiment of the present invention.

### DESCRIPTION OF REFERENCE NUMERALS

| | |
|---|---|
| 20: Light source unit array | 22, 24, 26: Light source unit |
| 25: Light axis | 30: Detection unit array |
| 32: Detection unit | 42, 44, 46: Prism |
| 47, 48: Prism interface | 50: Touch unit |

55a, 55b: Interface between touch unit and light source unit array
56a: Interface between touch unit and detection unit array

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

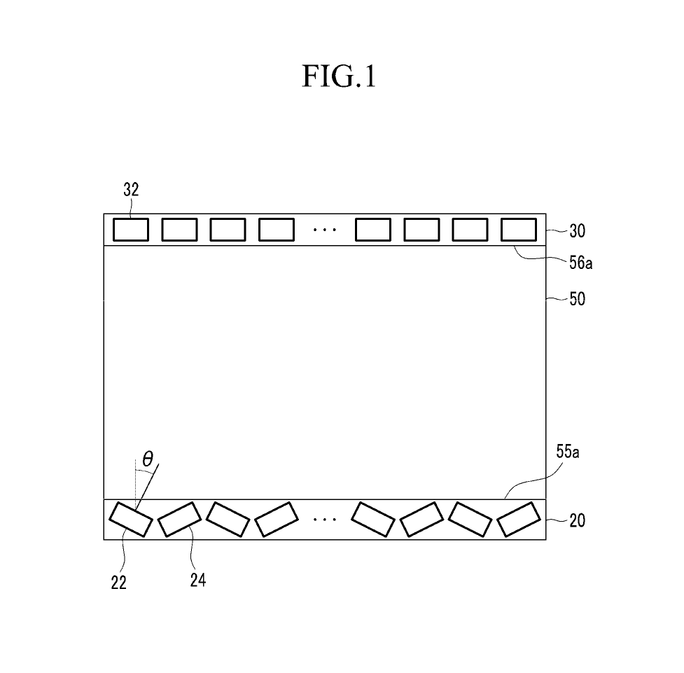

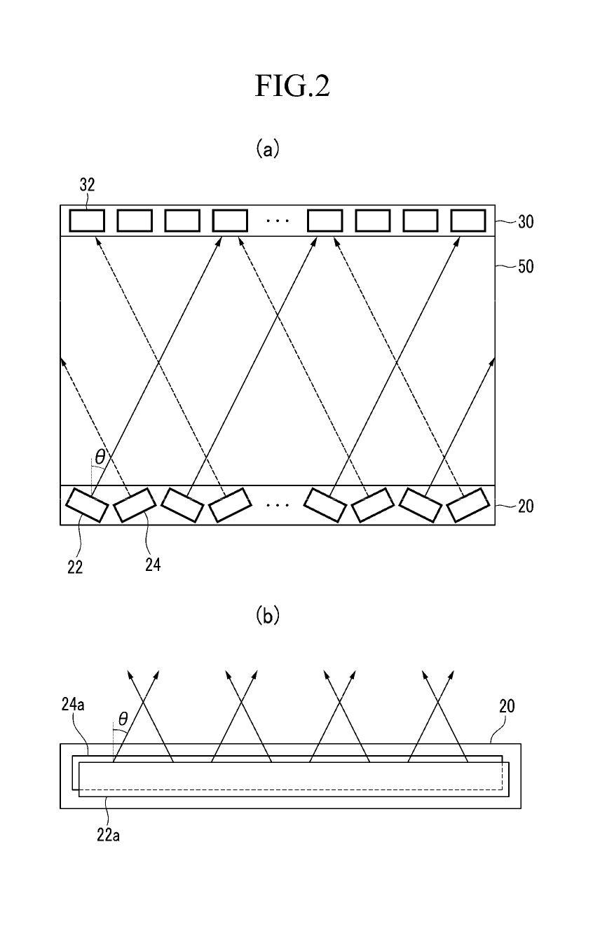

First, referring to FIGS. 1 and 2, a touch panel according to an exemplary embodiment of the present invention will be described in detail.

FIG. 1 is a plan view of a touch panel according to an exemplary embodiment of the present invention, and FIG. 2(a) is a plan view illustrating the propagation of light from a light source of a touch panel, and FIG. 2(b) is a plan view illustrating another example of the light source of a touch panel.

Referring to FIG. 1, the touch panel includes a touch unit 50 touchable by a user, a light source unit array 20 positioned along a first edge 55a which is one edge of the touch unit 50, and a detection unit array 30 positioned along a second edge 56a which is another edge of the touch unit 50 opposing the first edge 55a1.

The touch unit 50 may be a space of contained air or a material having a refractive index larger than 1. An example of the material having the refractive index larger than 1 is polymethyl methacrylate (PMMA) or acryl.

In the case in which the medium of the touch unit 50 is air, a boundary between the touch unit 50 and the light source unit array 20 or between the touch unit 50 and the detection unit array 30, as shown in FIG. 1, may not be present. Instead, the light source unit array 20 and the detection unit array 30 may be surrounded by air. If the touch unit 50 were made of a solid material such as PMMA, the boundaries of the touch unit 50 (including the first edge 55a and the second edge 56a) would be the edge of the solid material.

As used herein, the shortest line linking the second edge 56a on which the detection array 30 is positioned and the first edge 55a of the touch unit 50 on which the light source unit array 20 extends in a “reference direction.” As used herein, the reference direction would be perpendicular to the second edge 56a.

The light source unit array 20 includes first light sources 22 and second light sources 24.

Referring to FIG. 2(a), the first light source 22 radiates light at a preselected first angle θ to the right of the reference direction and the second light source 24 radiates light at the first angle θ to the left of the reference direction. Even in the case in which the touch unit 50 is made of a material having a refractive index larger than 1, the light radiated from each of the first light source 22 and the second light source 24 may be aimed in directions that make the first angle θ with respect to the reference direction. Sometimes, 50% or more of the light emitted from each of the first light source 22 and the second light source 24 may be focused in the direction of an “optical axis,” which makes the first angle θ with respect to the reference direction. The rest of the light amount may propagate in a direction off the optical axis. Even in this case, the light from each of the first light source 22 and the second light source 24 may be considered as propagating in the direction of the optical axis since that is the direction in which the light sources are aimed.

The light emitted from each of the first light source 22 and the second light source 24 may be infrared rays.

The first light sources 22 and the second light sources 24 may be alternately arranged as shown in FIG. 1. An interval between neighboring light beams of the first light source 22 or an interval between neighboring light beams of the second light source 24 may be set depending on the resolution of the touch unit 50, and may be smaller than the desired interval between two touch points to be discriminately sensed. The plurality of first light sources 22 may be driven sequentially or simultaneously. Similarly, the plurality of second light sources 24 may also be driven sequentially or simultaneously. The first light sources 22 and the second light sources 24 are driven in an alternating manner, such that one of the two groups of light sources are radiating light at a time.

Alternatively, as shown in FIG. 2(b), the first light sources 22 of FIG. 2(a) may extend in one body along the light source unit array 20 to form a substantially linear light source 22a and the second light sources 24 of FIG. 2(a) may also extend in one body along the light source unit array 20 to form a substantially linear light source 24a. The linear light source 22a and 24a may be implemented by using the first light sources 22 or the second light sources 24 more than the resolution of the touch unit 50.

The detection unit array 30 includes detection units 32 positioned at points at which the light from the first light sources 22 and the second sources 24 of the light source unit array 20 are aimed. In the case in which the first light sources 22 and the second light sources 24 are alternately arranged, the detection units 32 may be positioned such that the light beams from the first light sources 22 and the second light sources 24 reach each detection unit 32 with one to one correspondence. Alternatively, in the case when the first light sources 22 and the second light sources 24 respectively form substantially linear light sources, the detection unit 32 may also be linear so as to detect the light from the linear light sources. The detection unit 32 detects the light from the first light source 22 and the second light source 24, and in the case in which a touch occurs along the direction in which the light from the first light source 22 and the second light source 24 propagate, the detection unit 32 may detect a change in the light (e.g., a change in intensity or distribution).

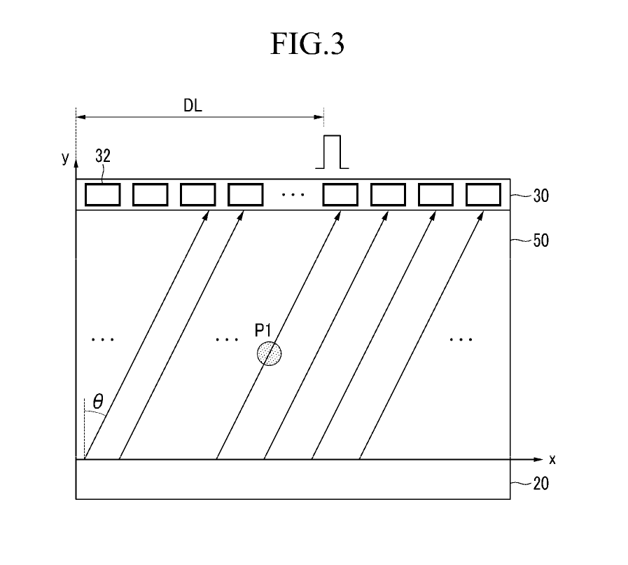

Hereinafter, referring to FIGS. 3, 4, and 5 in addition to FIGS. 1 and 2, a method of detecting a touch position when there is a single touch point described.

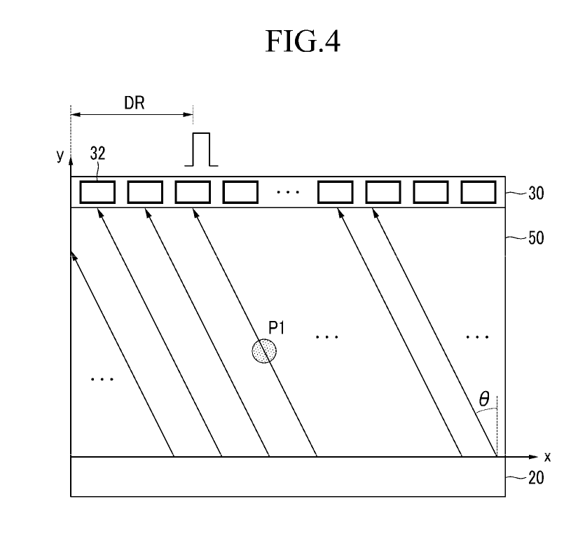

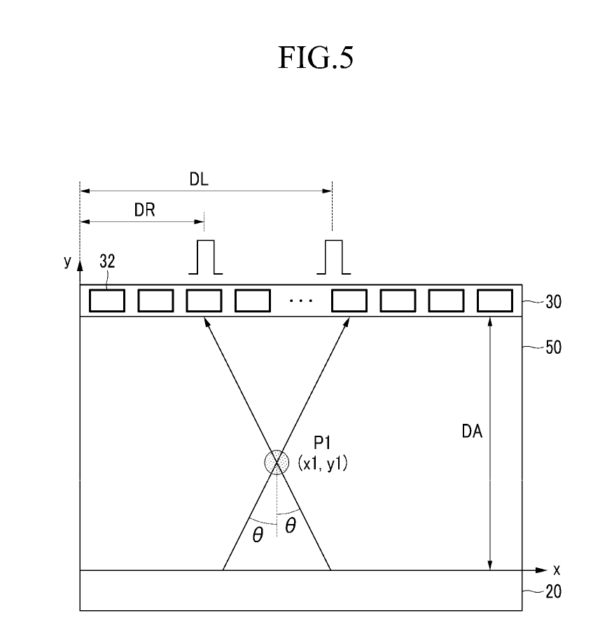

FIGS. 3 and 4 are plan view showing a method of acquiring a detection signal in the case of a single touch point according to an exemplary embodiment of the present invention. FIG. 5 is a plan view showing a method of calculating the coordinates of a touch position from the method shown in FIGS. 3 and 4.

Referring to FIG. 3, when a point P1 of the touch unit 50 is touched and light aimed at the first angle θ to the right of the reference direction radiates from the light source unit array 20, the detection unit 32 that is positioned to receive the light passing through the touch point P1 detects a change in the light relative to when there is no touch. In response to the change, and the detection unit 32 generates a detection signal. In the case in which the light source unit array 20 includes a plurality of first light sources 22, the plurality of first light sources 22 may radiate light beams sequentially or simultaneously. In the case in which the first light sources 22 are sequentially driven, only the detection unit 32 detecting the light from the particular first light source 22 that generates light passing through the point P1 may operate. Alternatively, a group of several detection units 32, such as the detection unit 32 detecting the light from the first light source 22 and some of the neighboring detection units, may operate. In some embodiments, all the detection units 32 may operate.

In the present embodiment, the detection unit 32 generating the detection signal is positioned apart from the y-axis line by a first distance DL. In FIGS. 3 and 4, the left vertical edge line of the touch unit 50 corresponds to the y-axis line. As shown in FIG. 5, the horizontal edge line of the touch unit 50 may form the x-axis line.

Referring to FIG. 4, light aimed at the first angle θ to the left of the reference direction radiates from the light source unit array 20. The detection unit 32 positioned to receive the light that passes through the touch point P1 detects a change in the light relative to when there is no touch, and generates a detection signal corresponding to the change. If the light source unit array 20 includes a plurality of second light sources 24, the plurality of second light sources 24 may radiate light beams sequentially or simultaneously. In the case in which the second light sources 24 are sequentially driven, only the detection unit 32 positioned to detect the light from the second light source 24 that generates the light passing through the point P1 may operate. Alternatively, a group of several detection units 32, such as the detection unit 32 detecting the light from the second light source 24 and some of the neighboring detection units, may operate. In some embodiments, all the detection units 32 may operate.

In the present embodiment, the detection unit 32 generating the detection signal is positioned apart from the y-axis line by a second distance DR.

The sequence of operations shown in FIGS. 3 and 4 may be inverted. That is, the first light source 22 may be firstly driven while the detection unit 32 detects the light from the first light source 22, and then the second light source 24 may be driven.

The detection signal generated by the detection unit 32 may constitute just one pulse. Further, where the touch point P1 falls on the paths of two or more light beams, two or more corresponding detection units 32 may generate the detection signal.

Referring to FIG. 5, the length of the touch unit 50 along the y-direction is represented by DA, and the coordinates (x1, y1) of the touch point P1 can be acquired by Equation 1.

x1=(DR+DL)/2

y1=DA−(DR−DL)/2 tan(π/2−θ) (Equation 1)

As such, when a touch is made while light beams radiate in different directions in an alternating manner, detection signals are generated by different detection units so as to accurately calculate the coordinates of the touch point.

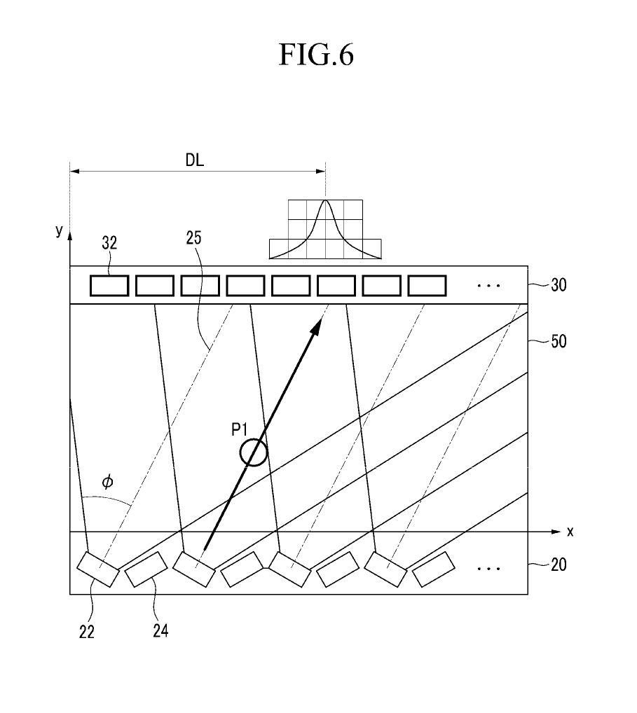

Next, referring to FIGS. 6, 7, and 8, a touch panel and a touch position detection method according to another embodiment of the present invention will be described. Like reference numerals designate like elements in the embodiment and the same description will be omitted.

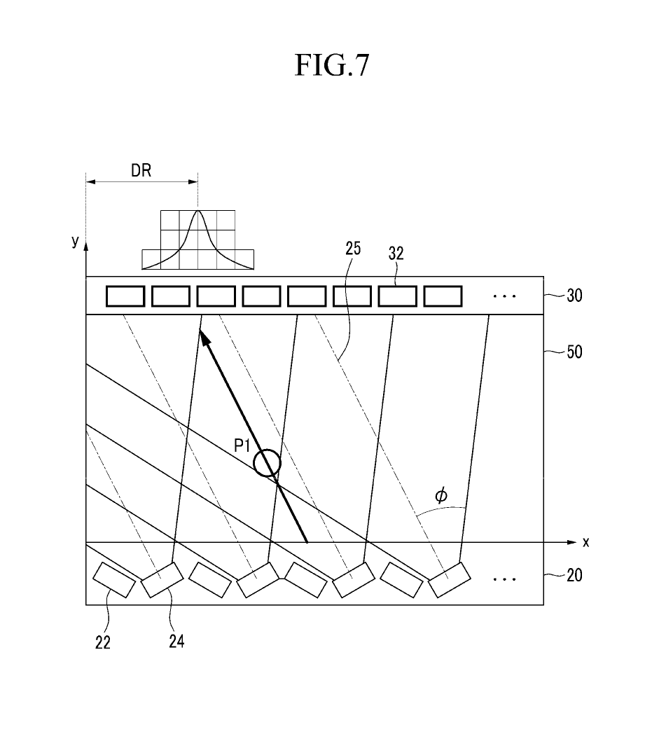

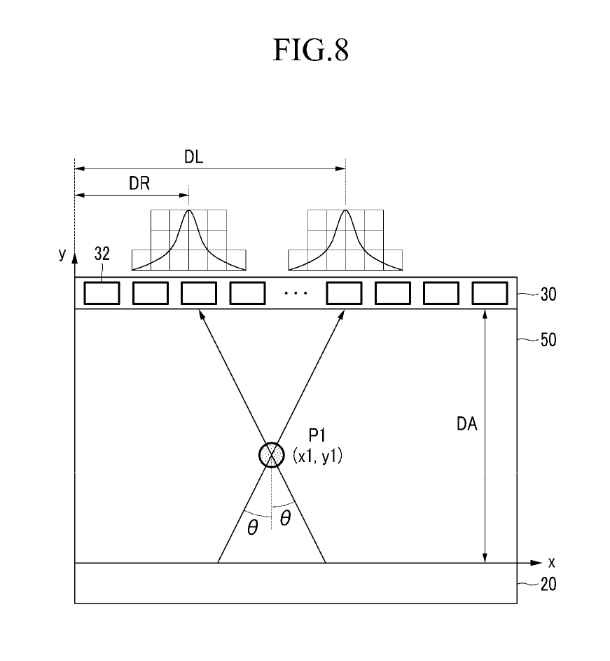

FIGS. 6 and 7 are plan views showing a method of acquiring a detection signal when there is one point of a touch, according to another embodiment of the present invention, and FIG. 8 is a plan view showing a method of calculating the position of the touch point based on the method shown in FIGS. 6 and 7.

The touch panel according to the present embodiment is almost the same as the embodiment described above, with a difference being that the light from each of the first light source 22 and the second light source 24 do not radiate in one direction but spreads over a predetermined angle φ on both sides of the optical axis 25. The optical axis 25 of the first light source 22 tilts to the right with respect to the reference direction at the first angle φ, and tilts to the left of the reference direction by the same angle φ for the second light source 24. Alternatively, the light from each of the first light source 22 and the second light source 24 may have an intensity distribution substantially forming a Gaussian distribution with respect to the optical axis 25.

Referring to FIG. 6, when one point P1 of the touch unit 50 is touched and the light beams from the first light sources 22 are radiated sequentially or simultaneously, a plurality of detection units 32 that receive the light beams that pass through the touch points P1 generate detection signals. In the case in which the first light sources 22 are sequentially driven, only the detection unit 32 that is positioned to detect the light from the first light source 22 that generates the light passing through the point P1 may operate. Alternatively, a group of several detection units 32, such as the detection unit 32 detecting the light from the first light source 22 and some of the neighboring detection units, may operate. In some embodiments, all the detection units 32 may operate.

As shown in FIG. 6, a plot of detection signals shows a peak value in the signal from the detection unit 32 that is positioned to receive a light beam that propagates at the first angle φ to the right of the reference line, which squarely falls on the touch point P1. The peak of the detection signal is positioned apart from the y-axis line by the first distance DL. The y-axis of the plot of detection signal may represent the magnitude of the detection signal, which is responsive to the change in the light relative to when there is no touch.

Referring to FIG. 7, when the light beams from the second light sources 24 are radiated sequentially or simultaneously, a plurality of detection units 32 corresponding to the light beams passing through the touch points P1 generate detection signals. In the case in which the second light sources 24 are sequentially driven, only the detection unit 32 positioned to detect the light from the second light source 24 that generates the light passing through the point P1 may operate. Alternatively, a group of several detection units 32, such as the detection unit 32 detecting the light from the second light source 24 and some of the neighboring detection units, may operate. In some embodiments, all the detection units 32 may operate.

As shown in FIG. 7, a plot of detection signals shows a peak value in the signal from the detection unit 32 that is positioned to receive a light beam that propagates at the first angle φ to the left of the reference line, which squarely falls on the touch point P1. The peak of the detection signal is positioned apart from the reference-axis line by the second distance DR.

The detection signal generated by the detection unit 32 may include just one pulse. Further, where the touch point P1 is on the paths of two or more light beams, two or more corresponding detection units 32 may generate the detection signal.

Referring to FIG. 8, the length of the touch unit 50 along the y-direction is represented by DA, and the coordinates (x1, y1) of the touch point P1 can be acquired by the Equation 1 provided above.

Various characteristics of the touch panel shown in FIGS. 1 to 5 described above apply to the embodiment of FIGS. 6, 7, and 8.

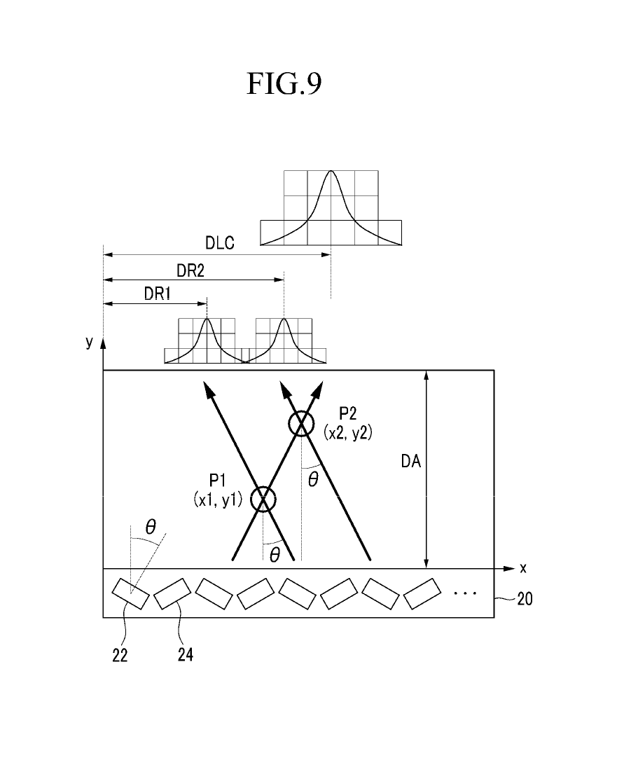

Next, referring to FIG. 9, a method of calculating the coordinates when there are two touch points P1, P2 will be described.

FIG. 9 is a plan view showing a method of calculating the coordinates by acquiring a detection signal when where are two points of a touch.

The touch panel according to the present embodiment of the present invention is substantially the same as the touch panel shown in FIGS. 1 to 5 or the touch panel shown in FIGS. 6 to 8. In the present case, however, there are two touch points P1 and P2. In particular, the two touch points P1 and P2 are positioned on the optical path of the light beam coming from the first light source 22. In the case in which the light from the first light source 22 spreads over an angular distribution range (e.g., as in FIG. 6), the two touch points P1 and P2 may be positioned on the optical axis of the same first light source 22.

When the first light sources 22 and the second light sources 24 of the light source unit array 20 alternately radiate light, the detection signal shown in FIG. 9 is generated by detecting a change in the light passing through the two touch points P1 and P2. The detection signal generated by a change in the light from the first light sources 22 generates one peak at a first distance DLC from the y-axis line. Each of two detection signals generated by a change in the light from the second light sources 24 has one peak, and distances of the peaks of the detection signals from the y-axis line are a second distance DR1 and a third distance DR2, respectively.

Therefore, the coordinates (x1, y1) of the touch point P1 and the coordinates (x2, y2) of the touch point P2 can be acquired through Equation 2 below in the same manner as FIGS. 5 and 8 described above.

x1=(DR1+DL)/2

y1=DA−(DR1−DL)/2 tan(π/2−θ)

x2=(DR2+DL)/2

y2=DA−(DR2−DL)/2 tan(π/2−θ) (Equation 2)

Various characteristics of the embodiment described above apply to the embodiment of FIG. 9. Further, the present invention is not limited to the case in which there are two touch points.

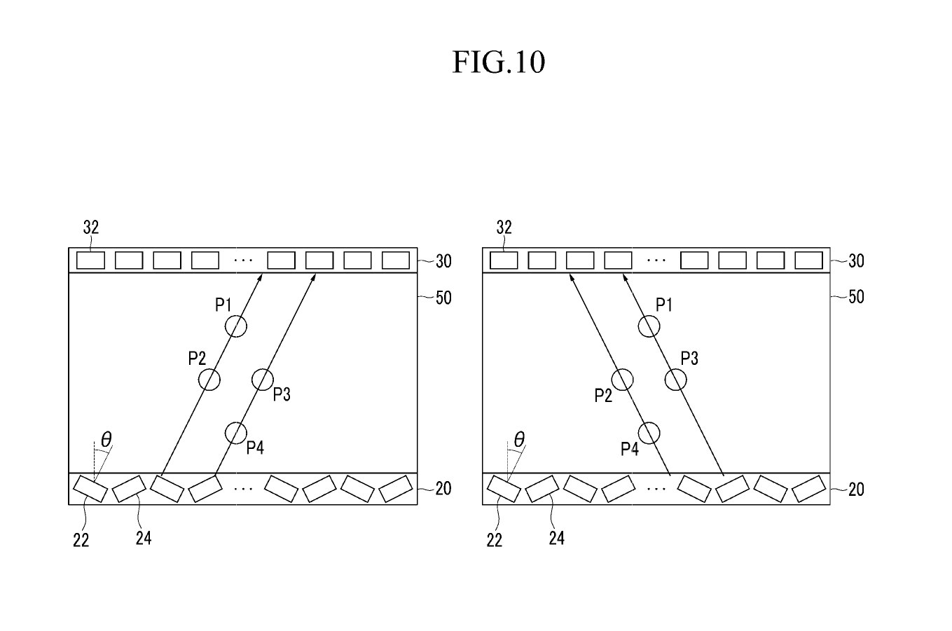

Next, referring to FIGS. 10, 11, and 12, a method of detecting the positions of multiple touch points will be described.

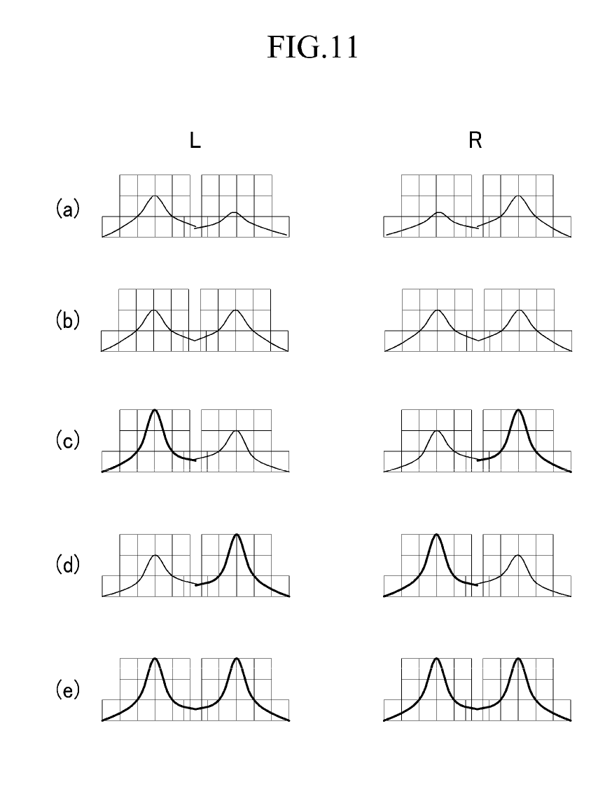

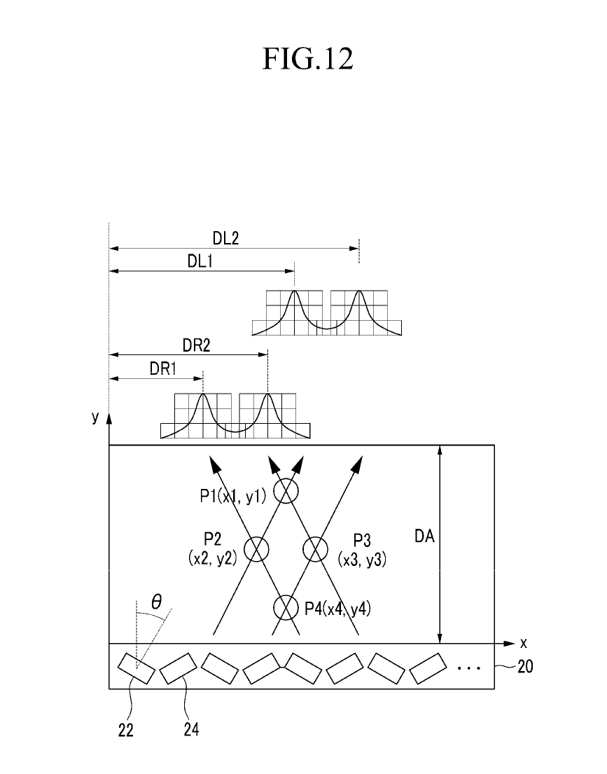

FIG. 10 is a plan view showing a method of acquiring a detection signal when two or more points of a touch panel are touched, FIG. 11 is a diagram showing various forms of the detection signal acquired by the method of FIG. 10, and FIG. 12 is a plan view showing a method of calculating the coordinates of a position of a touch point from the method shown in FIG. 10.

The touch panel according to the present embodiment of the present invention is substantially the same as the touch panel shown in FIGS. 1 to 5 or the touch panel shown in FIGS. 6 to 8. In the present case, however, touch points of two to four at maximum P1, P2, P3, and P4 are touched. In particular, when four touch points P1, P2, P3, and P4 are touched, the two touch points P1 and P2 and the two touch points P3 and P4 are respectively positioned on the same optical path from the first light source 22 or on the optical axis of the same first light source 22. Similarly, touch points P1 and P3 and touch points P2 and P4 are respectively positioned on the same optical path from the second light source 24 or on the optical axis of the same second light source 24. Therefore, at a first glance, the detection signal may seem to indicate the presence of two, not four, touch points.

When the first light source 22 and the second light source 24 of the light source unit array 20 alternately radiate light, the detection signal as shown in FIG. 11 is generated due to change in the property of light passing through the four touch points P1, P2, P3, and P4. In the present embodiment, the detection signal generated by the change in the light from the first light source 22 includes two detection signals each having one peak, and the detection signal generated by the change in the light from the second light source 24 also includes two detection signals each having one peak.

In FIG. 11, the reference numerals ‘L’ and ‘R’ for representing the columns are characters for discriminating detection signals when the first light source 22 radiates light and detection signals when the second light source 24 radiates light. Further, in FIG. 11, the peak of the detection signal when one touch point is present on the path of the light from the first light source 22 or the second light source 24 has a height equal to one scale or two scales depending on the position of the touch point, and the peak of the detection signal when two touch points are present on the light route has a height equal to three scales. The vertical axis of the detection signal may represent, for example, the magnitude of the detection signal, which is responsive to the change in the light relative to when there is no touch.

FIG. 11(a) shows a case in which the touch point P1 and the touch point P4 in FIG. 10 are touched. The left detection signal disposed on the L column and the right detection signal disposed in the R column respectively have a peak relatively higher than the rest detection signals, which are signals generated in the absence of any touch. A detection signal having a relatively lower peak corresponds to a case in which the touch point is relatively far from the detection unit 32, such as the touch point P4.

FIG. 11(b) shows a case in which the touch point P2 and the touch point P3 in FIG. 10 are touched. The two detection signals of the L column and all detection signals of the R column have substantially the same peak because the points P2 and P3 are about the same distance up the y-axis.

FIG. 11(c) shows a case in which the touch point P1, the touch point P2, and the touch point P3 in FIG. 10 are touched. The left detection signal of the L column and the right detection signal of the R column have a peak comparatively higher than the rest detection signals. The peak of the detection signal having a comparatively higher peak has a height equal to three scales. In this case, two touch points are present on the route of the light from the first light source 22 or the second light source 24. Therefore, the left detection signal of the L column is generated by light on a path that overlaps the touch points P1 and P2, and the right detection signal of the R column is generated by light on a path that overlaps the touch points P1 and P3.

FIG. 11(d) shows a case in which the touch point P2, the touch point P3, and the touch point P4 in FIG. 10 are touched. In this case, a right detection signal of the L column and a left detection signal of the R column have a peak comparatively higher than the rest detection signals. Herein, the peak of the detection signal having a comparatively higher peak has a height equal to three scales. In this case, two touch points are present on the route of the light from the first light source 22 or the second light source 24. Therefore, the right detection signal of the L column is generated by light on a path that overlaps the touch points P3 and P4, and the left detection signal of the R column is generated by light on a path that overlaps the touch points P2 and P4.

FIG. 11(e) shows a case in which all the touch points P1, P2, P3, and P4 in FIG. 10 are touched. All the detection signals have a peak having the height of approximately three scales. The left detection signal of the L column is generated by the light on the path that overlaps the touch points P1 and P2, and the right detection signal of the L column is generated by the light on the path that overlaps the touch points P3 and P4. The left detection signal of the R column is generated by the light on the path that overlaps the touch points P2 and P4, and the right detection signal of the R column is generated by the light on the path that overlaps the touch points P1 and P3.

Referring to FIG. 12, it is possible to acquire the coordinates of touch positions through the positions of the peaks in the four detection signals. When the first light sources 22 are driven and the positions of two peaks of a detection signal are represented by the distance DL1 and the distance DL2, the coordinates (x1, y1), (x2, y2), (x3, y3), and (x4, y4) of all the touch points P1, P2, P3, and P4 may be calculated by Equation 3 similarly to the embodiment described above. Similarly, when the second light sources 24 are driven and the positions of two peaks of a detection signal are represented by the second distance DR1 and the second distance DR2, respectively, the coordinates (x1, y1), (x2, y2), (x3, y3), and (x4, y4) of all the touch points P1, P2, P3, and P4 may be calculated by Equation 3.

x1=(DR2+DL1)/2, y1=DA−(DR2−DL1)/2 tan(π/2−θ)

x2=(DR1+DL1)/2, y2=DA−(DR1−DL1)/2 tan(π/2−θ)

x3=(DR2+DL2)/2, y3=DA−(DR2−DL2)/2 tan(π/2−θ)

x4=(DR1+DL2)/2, y4=DA−(DR1−DL2)/2 tan(π/2−θ) (Equation 3)

As such, by analyzing the heights and positions of the peaks of the detection signal of the detection unit 32, it is possible to accurately detect the number of the touch positions and coordinates of the touch positions even though two or more touch points are present on the same optical path or on the same optical axis.

The analysis of the detection signal and the method of detecting the coordinates of the touch position presented herein are not limited to a case in which there are four touch points.

Various characteristics of the embodiment described above apply to the embodiment of FIG. 12.

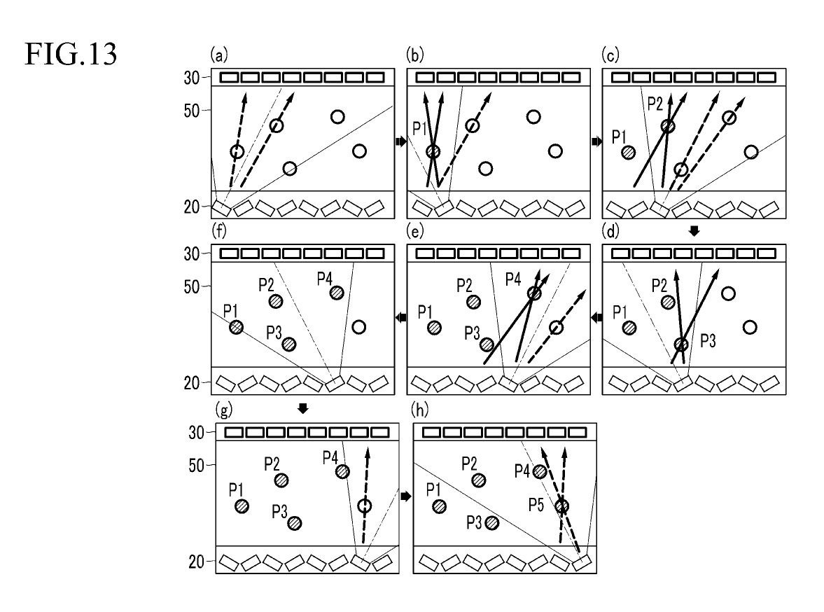

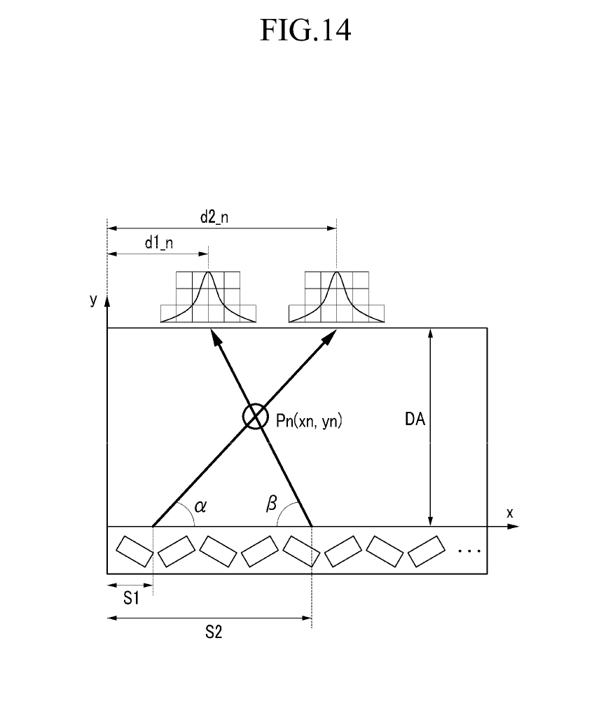

FIGS. 13 and 14 illustrate the case of multiple touch points that do not land on the same optical path or on the same optical axis.

FIG. 13 is a plan view showing a method of acquiring a detection signal when five points of a touch panel are touched according to an exemplary embodiment of the present invention, and FIG. 14 is a plan view showing a method of calculating the coordinates of a position of each touch point from the method shown in FIG. 13.

In the present embodiment, the above-mentioned touch panel shown in FIGS. 6 to 8 will be described as an example. That is, the light source unit array 20 includes the first light sources 22 and the second light sources 24 that are alternately arranged. Each of the first light source 22 and the second light source 24 radiates light that spreads within an angular range from an optical axis 25.

Referring to FIG. 13, for example, five touch points are present in the touch unit 50, and the first light sources 22 and the second light sources 24 of the light source unit array 20 are sequentially driven from one end of the light source unit array 20 to the other.

Referring to FIGS. 13(a) and 13(b), the touch point P1 is positioned on the path of the light from the first light source 22 and the second light source 24 adjacent to each other, such that the corresponding detection unit 32 generates a detection signal having two peaks.

Referring to FIGS. 13(a) and 13(c), the touch point P2 is positioned on the path of the light from the two first light sources 22 adjacent to each other, such that the corresponding detection unit 32 generates a detection signal having two peaks.

Referring to FIGS. 13(c) and 13(d), the touch point P3 is positioned on the path of the light from the first light source 22 and the second light source 24 adjacent to each other, such that the corresponding detection unit 32 generates a detection signal having two peaks.

Referring to FIGS. 13(c) and 13(e), the touch point P4 is positioned on the path of the light from of the two first light sources 22 adjacent to each other, such that the corresponding detection unit 32 generates a detection signal having two peaks.

Referring to FIGS. 13(g) and 13(h), the touch point P5 is positioned on the path of the light of the first light source 22 and the second light source 24 adjacent to each other, such that the corresponding detection unit 32 generates a detection signal having two peaks.

Referring to FIG. 14, the peaks of the two detection signals for each of the touch points P1, P2, P3, P4, and P5 may be obtained at distances d1_n and d2_n from the y-axis line. Further, the first light source 22 or the second light source 24 that radiates light for determining the peaks of the detection signal are located at a distance s1 or s2 from the y-axis line, as acquired by sequential driving of the light source unit array 20. Similarly, the angles α and β formed by the light with the first edge 55a can be acquired through sequential driving of the light source unit array 20. Through such acquired information, the coordinates (xn, yn) (n=1, 2, . . . ) of each touch point (Pn) (n=1, 2, . . . ) can be acquired from Equation 4 below.

xn=s1+(s2−s1)tan β/(tan β+tan α)

yn=(s2−s1)tan α*tan β/(tan β+tan α)

tan α=DA/(d2_{—}n−s1), tan β=DA/(S2−d1_{—}n) (Equation 4)

Herein, DA represents a length of the touch unit 50 in the y-axis direction.

The method of detecting the coordinate of the touch point in the embodiment is not limited to the case in which the number of the touch points is 5.

Besides, various characteristics of the embodiment described above may be applied to the embodiment in the same manner.

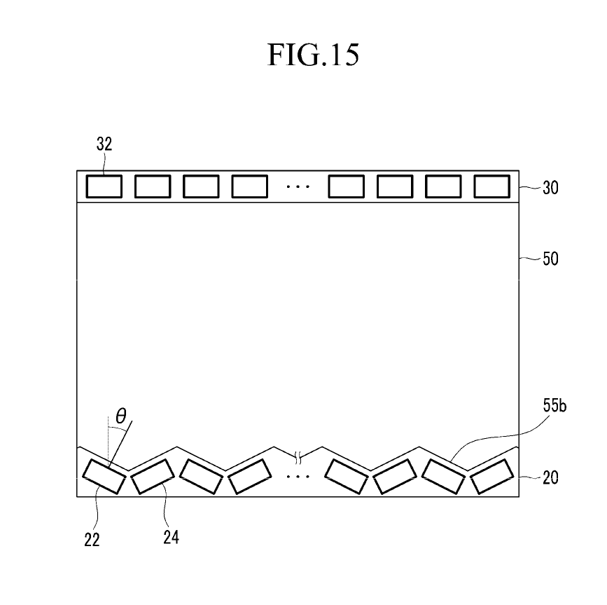

Next, referring to FIGS. 15, 16, and 17, a touch panel according to another embodiment of the present invention will be described. Like reference numerals designate like elements in the embodiment and redundant description will be omitted.

FIGS. 15 to 17 are plan views of a touch panel according to another embodiment of the present invention.

First, referring to FIG. 15, the touch panel according to the embodiment of the present invention is the same as the touch panel shown in FIGS. 1 to 5 or the touch panel shown in FIGS. 6 to 8, with a primary difference being that an interface 55b between the touch unit 50 and the light source unit array 20 has bends. More specifically, the interface 55b is bent to keep a substantially constant distance from the light radiation surfaces of the first light sources 22 and the second light sources 24, which are arranged tilted with respect to the x-axis line. In this case, the “reference direction” may refer to a direction that is perpendicular to an interface between the detection unit array 30 and the touch unit 50. A line that is perpendicular to the interface 55b forms the first angle θ with respect to the reference direction. By this configuration, in the case in which a medium forming the touch unit 50 is made of a material having a refractive index larger than 1, it is possible to prevent a radiation direction of the light from being changed due to refraction of the light from each of the first light source 22 and the second light source 24 at the interface 55b.

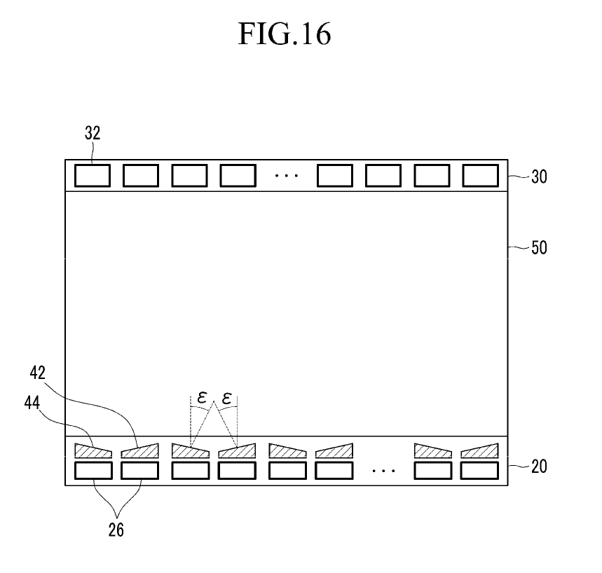

Referring to FIG. 16, the touch panel according to the present embodiment is the same as the touch panel shown in FIGS. 1 to 5 or the touch panel shown in FIGS. 6 to 8, but the light source unit array 20 includes a plurality of third light sources 26, a plurality of first prisms 42 and a plurality of second prisms 44 that are respectively arranged in a line.

Light emitted from the third light source 26 is not aimed at an angle with respect to the reference direction, unlike in the previous embodiments. However, the light is radiated in the reference direction. The first prism 42 and the second prism 44 for changing the direction of light propagation are positioned in front of a light radiation surface of each of the third light sources 26.

The first and second prisms 42, 44 have surfaces that are at an angle with respect to the light sources 26. More specifically, the first prism 42 has a surface that is inclined to the left with respect to the reference direction at a predetermined angle ε, and the second prism 44 has a surface that is inclined to the right with respect to the reference direction at the predetermined angle ε. The inclined surfaces are, at least in the embodiment shown, surfaces that are farthest from the light sources 26. The first prism 42 directs the light from the third light source 26 in a direction that is to the right with respect to the reference direction, and the second prism 44 directs the light from the third light source 26 in a direction that is to the left with respect to the reference direction. By controlling the angle ε, the light from the third light source 26 can be directed in a direction that forms the first angle θ with respect to the reference direction.

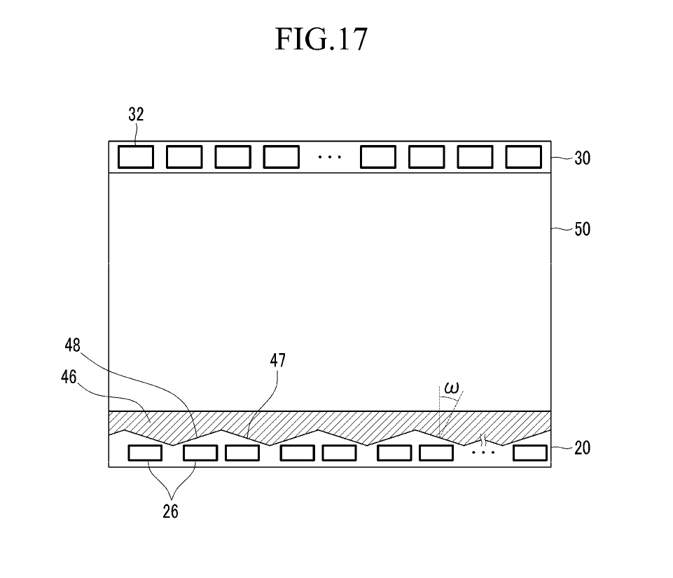

Lastly, referring to FIG. 17, the touch panel according to the present embodiment is substantially the same as the above-mentioned touch panel shown in FIG. 16, but the light source unit array 20 includes a third prism 46 positioned between the third light source 26 and the touch unit 50 instead of a plurality of prisms as in the embodiment of FIG. 16.

The surface of the third prism 46 facing the third light sources 26 is bent at a location corresponding to a boundary between the neighboring third light sources 26. The surfaces of the third prism 46 facing the third light sources 26 are herein referred to as the surfaces 47, 48. The surfaces 47 and 48 of the third prism 46 corresponding to the third light sources 26 are flat, and perpendicular lines to the flat surfaces 47 and 48 form an angle ω with respect to the radiation direction of the light from the third light source 26.

The flat surface 47 of the third prism 46 directs the light from the third light source 26 to be radiated in a direction to the right with respect to the reference direction, and the flat surface 48 of the third prism 46 allows the light from the third light source 26 to be radiated in a direction to the left with respect to the reference direction. By controlling the angle ω at which the perpendicular lines to the flat surfaces 47 and 48 of the third prism 46 are inclined with respect to the reference direction, the light from the third light source 26 can be radiated in a direction inclined at the first angle θ with respect to the reference direction in the touch unit 50.

The characteristics of the touch panel according to the above-mentioned embodiments apply to the embodiment of FIGS. 15 to 17.

In the several embodiments of the present invention, although the general optical-type touch panel has been primarily described, the embodiment may also be applied to a touch panel using a frustrated total internal reflection (FTIR) scheme.

As described in the embodiment of the present invention, it is possible to generate two or more detection signals having peaks by alternately radiating light beams in different directions. By doing so, the coordinates of the touch point can be accurately calculated through the peak positions of the detection signal.

Also, even in the case in which two or more touch points are generated in the touch unit of the touch panel, it is possible to accurately calculate the number of the touch points and the coordinates of the touch points even though two or more touch points are present on the same optical path or on the same optical axis by analyzing the peak positions of the detection signal and the height of the peak of the detection signal.

The calculations entailed in the above methods may be executed by a processor and a memory incorporated into the touch panel device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A touch panel, comprising:
a touch unit that receives a touch;
a light source unit array positioned along a first edge of the touch unit and including a first light source and a second light source; and
a detection unit array positioned along a second edge facing the first edge of the touch unit and including a detection unit generating a detection signal by detecting light from the light source unit array,
wherein the first light source radiates light having a first optical axis to the touch unit, the first optical axis extending in a first direction that makes a first angle with respect to a reference direction,
the second light source radiates light having a second optical axis to the touch unit, the second optical axis extending in a second direction that makes the first angle with respect to the reference direction, and
the first direction and the second direction are opposite of each other with respect to the reference direction, wherein the reference direction extends between the light sourc eunit array and the detection unit array perpendicularly to the second edge.

2. The touch panel of claim 1, wherein:
50% or more of the light emitted from the first light source is focused in a direction of the first optical axis, and 50% or more of the light emitted from the second light source is focused in a direction of the second optical axis.

3. The touch panel of claim 2, wherein:
the first light source and the second light source are alternately driven.

4. The touch panel of claim 3, wherein:
the detection unit detects a change in the light from the first light source when the first light source is driven to generate a first detection signal, and detects a change in the light from the second light source when the second light source is driven to generate a second detection signal.

5. The touch panel of claim 4, wherein:
at least one of the first light source and the second light source comprises a substantially linear light source extending along the light source unit array.

6. The touch panel of claim 4, wherein:
at least one of the first light source and the second light source are provided in plural, and the plurality of light sources are disposed in a line in the light source unit array.

7. The touch panel of claim 2, wherein:
the detection unit detects a change in the light from the first light source when the first light source is driven to generate the first detection signal, and detects a change in the light from the second light source when the second light source is driven to generate the second detection signal.

8. The touch panel of claim 2, wherein:
at least one of the first light source and the second light source comprises a substantially linear light source extending along the light source unit array.

9. The touch panel of claim 2, wherein:
at least one of the first light source and the second light source are provided in plural, and the plurality of light sources are disposed in a line in the light source unit array.

10. The touch panel of claim 2, wherein:
the touch unit includes a material having a refractive index of 1 or higher.

11. The touch panel of claim 1, wherein:
the light emitted from the first light source is radiated in directions having a range from a direction of the first optical axis to a direction that makes a second angle with respect to the direction of the first optical axis, and the light emitted from the second light source is radiated in directions having a range from a direction of the second optical axis to a direction that makes the second angle with respect to the direction of the second optical-axis.

12. The touch panel of claim 11, wherein:
the first light source and the second light source are alternately driven.

13. The touch panel of claim 12, wherein:
the detection unit detects a change in the light from the first light source when the first light source is driven to generate a first detection signal, and detects a change in the light from the second light source when the second light source is driven to generate a second detection signal.

14. The touch panel of claim 13, wherein:
at least one of the first light source and the second light source are provided in plural, and the plurality of light sources are disposed in a line in the light source unit array.

15. The touch panel of claim 11, wherein:
the detection unit detects a change in the light from the first light source when the first light source is driven to generate a first detection signal, and detects a change in the light from the second light source when the second light source is driven to generate a second detection signal.

16. The touch panel of claim 11, wherein:
at least one of the first light source and the second light source are provided in plural, and the plurality of light sources are disposed in a line in the light source unit array.

17. The touch panel of claim 11, wherein:
the touch unit includes a material having a refractive index of 1 or higher.

18. The touch panel of claim 1, wherein:
a first edge of the touch unit bends along surfaces of the first light source and the second light source.

19. The touch panel of claim 1, wherein:
the first angle is equal to zero so that a direction of the first optical axis of the light emitted from the first light source and a direction of the second optical axis of the light emitted from the second light source are the reference direction.

20. The touch panel of claim 19, wherein:
the light source unit array further comprises a prism between the first and second light sources and the touch unit, and
the prism directs the light from the first light source in the first direction and the light from the second light source in the second direction in the touch unit.

21. A touch position detection method of the touch panel of claim 1, the method comprising:
sensing at least one touch at a touch point;
generating a first detection signal corresponding to the touch point by driving a first light source;
generating a second detection signal corresponding to the touch point by driving a second light source; and
calculating coordinates of the touch point from positions of a peak of the first detection signal and the second detection signal.

22. The method of claim 21, wherein:
50% or more of the light emitted from the first light source is focused in a direction of the first optical axis, and 50% or more of the light emitted from the second light source is focused in a direction of the second optical axis.

23. The method of claim 22, wherein:
in the calculating of the coordinates of the touch point, a radiation direction of light from the first light source and the second light source passing through the touch point make the first angle with respect to the reference direction.

24. The method of claim 22, wherein:
two or more touch points are positioned on a same optical axis of light emitted from at least one of the first light source and the second light source, and
detecting a position of the touch point by analyzing a height of the peak of the first detection signal and a height of the peak of the second detection signal.

25. The method of claim 21, wherein:
the light emitted from the first light source spreads within a second angle with respect to the first optical axis in either direction of the first optical axis, and the light emitted from the second light source spreads within the second angle with respect to the second optical axis in either direction of the second optical axis.

26. The method of claim 25, wherein:
in the calculating of the coordinates of the touch point, a radiation direction of light from the first light source and the second light source passing through the touch point makes the first angle with respect to the reference direction.

27. The method of claim 25, further comprising:
detecting a position of the at least one touch point by analyzing the height of the peak of the first detection signal and the height of the peak of the second detection signal.

28. The method of claim 25, wherein:
each of the first light source and the second light source is provided in plural, and the plurality of first light sources and the plurality of second light sources are alternately disposed, further comprising driving the plurality of first light sources and the plurality of second light sources sequentially from one end of the light source arary to the other.

29. The method of claim 28, wherein:
the calculating of the coordinates of the touch point comprises using positions of the first light source and the second light source emitting light passing through the touch point.
